(19) United States
(12) Patent Application Publication
(10) Pub. No.: US 2026/0189594 A1
(43) Pub. Date: Jul. 2, 2026

(54) SYSTEMS AND METHODS FOR BREACH AND ATTACK SIMULATIONS

(71) Applicant: Hive Pro Inc., Milpitas, CA (US)

(72) Inventors: Anand Choudha, Dubai (AE); Amit Mishra, Jamshedpur (IN); Jeelan Basha Poola, Bangalore (IN); Purvi Garg, Greater Noida (IN); Sarfaraz Abdul Ralhan Kazi, Dubai (AE)

(21) Appl. No.: 19/434,122

(22) Filed: Dec. 29, 2025

Related U.S. Application Data
(60) Provisional application No. 63/739,510, filed on Dec. 28, 2024.

(51) Int. Cl. H04L 9/40

(52) U.S. Cl. CPC H04L 63/1433

(57) ABSTRACT

A system includes a computing device that executes steps to, based on an event, establish and carry out simulated attacks on one or more assets within an organization or a network. The computing device determines vulnerabilities to one or more of the assets based on information associated with the event and executes the simulated attacks. Based on the results of the attacks, the computing device can carry out a series of remedial actions to strengthen the resistance of the assets to actual future attacks.

This application claims priority to U.S. provisional application 63/739,510, filed Dec. 28, 2024. U.S. provisional application 63/739,510 and all other extrinsic references contained herein are incorporated by reference in their entirety.

### FIELD OF THE INVENTION

The field of the invention is cybersecurity solutions.

### BACKGROUND

The background description includes information that may be useful in understanding the present invention. It is not an admission that any of the information provided herein is prior art or relevant to the presently claimed invention, or that any publication specifically or implicitly referenced is prior art.

As cyber threats become more sophisticated and frequent, security teams are tasked with defending complex infrastructures using a wide array of tools and techniques. While continuous or periodic security testing, such as Breach and Attack Simulation (BAS), has proven effective, it often leads to operational overhead, generating noise and unnecessary alerts. These simulations run on schedules without consideration for contextual, real-time risk factors, burdening Security Operations Centres (SOCs) and potentially missing high-priority threats.

Traditional BAS platforms often rely on continuous or periodic simulations to assess an organization's security controls. While this ensures thorough testing, it introduces significant challenges:
1) Noise in the SOC: Frequent simulations, especially when scheduled at regular intervals, generate high volumes of alerts and data that SOC teams must sift through. This noise can overwhelm security analysts and obscure real threats.
2) Performance Impact: Periodic simulations consume resources—both human and computational—that could be better allocated to real-time threat management. Simulations may also create unnecessary load on the infrastructure, impacting network performance.
3) Diminishing Returns: Continuous simulations can lead to alert fatigue, where SOC analysts grow desensitized to alerts, reducing their ability to respond effectively to critical threats.

Another drawback of traditional approaches is their lack of context. Simulations performed by existing systems and according to existing methodology do not take into account the dynamic nature of the threat landscape or changes within an organization's infrastructure. Without context-aware triggers, security testing may fail to identify evolving risks, leaving organizations vulnerable to attack.

Thus, there is still a need for systems and methods of breach and attack simulations that can incorporate relevance and context into execution, improving upon the systems of the past.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The inventive subject matter provides apparatus, systems and methods in which a computer system receives an event trigger associated with a real-world event. The computer system checks the event and determines a list of simulated attacks for the event. The computer system then runs one or more simulated attacks based on the event and, upon successful completion of the simulation, validates the security controls over assets or over a network that exist to block the type of attack that was simulated. The computer system then determines how successful the simulated attack was and correlates it with one or more vulnerabilities within assets from a collection of assets or within a network to which the assets belong. The computer system adjusts a vulnerability risk and asset risk based on this determination and can perform an action. Actions can include remedial actions to reduce the vulnerability risk or an asset risk.

In embodiments of the inventive subject matter, the event can include adding an asset to the network, receiving a threat advisory about an emerging or new threat, or the results of a vulnerability scan (the vulnerability scan showing a greater risk of vulnerability than a threshold, for example).

### BRIEF DESCRIPTION OF THE DRAWING

FIG. 1 illustrates a flowchart of the processes executed by a computing device or system (used interchangeably herein), according to embodiments of the inventive subject matter.

FIG. 2 is a diagrammatic overview of a system that implements the functions and processes according to embodiments of the inventive subject matter.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise one or more processors configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

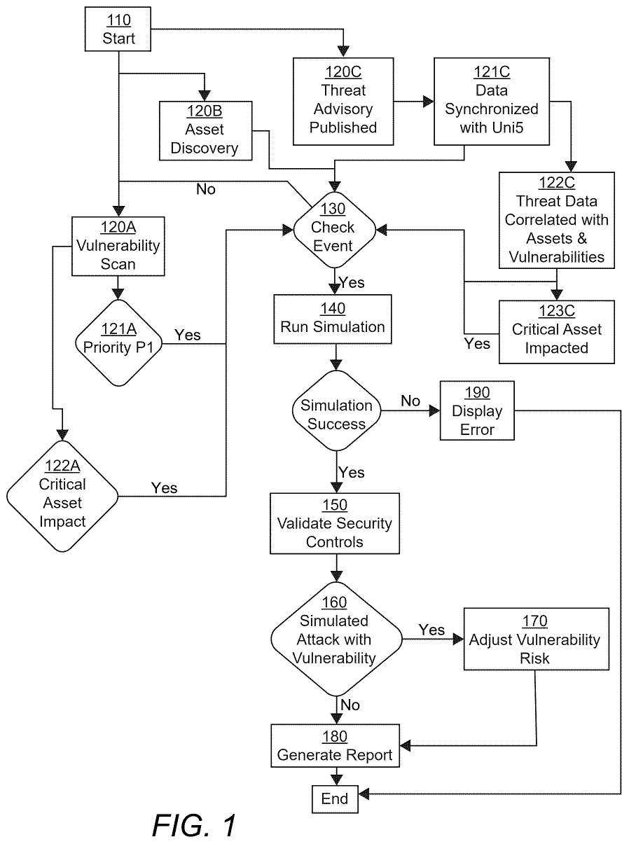

FIG. 1 illustrates a flowchart of the processes executed by a computing device or system (used interchangeably herein), according to embodiments of the inventive subject matter.

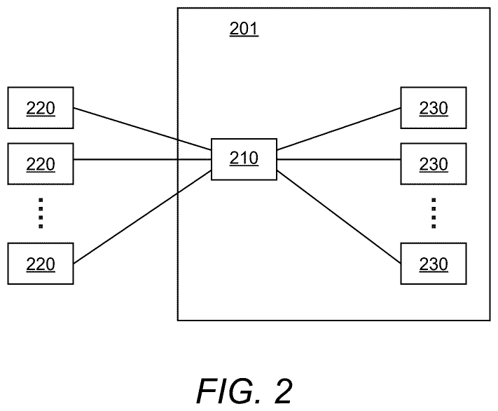

At step 110, the computing device 210 (seen in FIG. 2) receives an event trigger associated with a real-world event. As used herein, an event trigger refers to a trigger that causes the computing device 210 to execute the processes discussed herein. A real-world event can be considered to be an external occurrence that necessitates the event trigger. In the embodiments discussed herein, the real-world events can include the publication of a threat advisory, the discovery of a new asset 230 (e.g., devices or systems added to a particular network zone, department, or VLAN), or a vulnerability scan result. However, other real-world events such as disruptions due to natural disasters, conflict, etc., are contemplated as well and can be seamlessly incorporated into the system.

A threat advisory can include information regarding one or more of the latest vulnerabilities that are affecting a specific industry or geography. It could also include information such as information about an attacker group that has become active in the geography and known to act on certain kind of vulnerabilities. “Latest vulnerabilities” can be considered to refer to vulnerabilities that have become known within a certain amount of time up to the threat advisory. The time period can be a periodic calendar period such as a day, a week, a month, etc. The time period can also refer to the time since the last threat advisory such that any new threat advisory includes any threats or vulnerabilities that have become known since the prior threat advisory.

Depending on the type of event trigger, the computing device 210 can execute different initial steps. As seen in FIG. 1, the three types of event triggers that are illustrated are a vulnerability scan result 120A, an asset discovery 120B, and a new published threat advisory 120C.

At step 120A, the computing device 210 determines that the received event trigger corresponds to the results of a vulnerability scan. The computing device 210 then checks the level of priority of the vulnerability scan at step 121A. In parallel, the computing device 210 also determines whether any critical vulnerabilities have been identified that have been actively exploited or could be exploited by known threat actors at step 122A. The vulnerability scan can be performed by the computing device 210 as a part of step 120A and generate the event trigger itself, or by another computer device that sends the event trigger to the computing device 210. In an example, the vulnerability scan can be a scan of each of the assets 230 for known vulnerabilities, and reporting those assets 230 and their identified vulnerabilities.

Vulnerability scans generally are known in the art. These scans try and detect or match known vulnerabilities in computer devices. Examples of vulnerability scans can include anti-virus/anti-malware scans as well as scans of vulnerabilities existing in computer systems themselves in view of known threats.

It is contemplated that some scans can be performed at a prior time and these historical scans, and their identified vulnerabilities, can be considered by the system.

The computing device 210 can be programmed to dynamically prioritize the vulnerabilities ingested therein (either by presently-performed detection or historical) based on changes to the vulnerability exploitability in the real world.

For example, a given vulnerability may not be immediately exploitable but can become exploitable one month down the line when the attackers find ways to exploit it. This type of analysis can be performed by the computer device 210 or received from an outside computing device based on intelligence such as typical times to exploit from historical vulnerabilities, estimated values in exploits, or other factors.

In embodiments, vulnerability scans can comprise one of two types—agent based, network based credentialed scans and network based non-credentialed scans. Scans that are done through an agent that is installed on a computer system or network based credentialed scans are the most reliable in terms of accuracy.

In embodiments, the system can include a correlation engine stored and executed by the computing device 210. The correlation engine continuously analyzes the vulnerabilities ingested into the computing device 210 and correlates it against a vulnerability and threat intelligence database collected using a combination of automated and manual processes. This database includes information about the vulnerabilities such as maturity of vulnerability exploit code, social media chatter about vulnerabilities, hacker discussions on surface and dark web forums, threat actor behaviors and interest in vulnerabilities, known cyberattacks carried out using specific vulnerabilities, Mitre ATT&CK TTPs corresponding to vulnerabilities, patch information, alternative remediation options, etc. All these parameters are collectively utilized in conjunction with environmental context about the impacted assets such as business vertical of organization, geolocation, etc. to decide the criticality and exploitability of a vulnerability.

If the computing device 210 concludes that there are critical vulnerabilities that are actively exploited or could be exploited, it passes on to check the event at step 130.

After determining that the event trigger is associated with discovering a new asset or receiving a report of a new asset added to a network, system, organization etc., at step 120B the computing device 210 proceeds to step 130 to check the event.

The discovery of new assets can be performed by the computing device 210 or another computing device within organization 201 prior to the generation of the event trigger and the execution of step 120B. The discovery of new assets can be performed by any new assets reporting into the responsible computing device, which can, in addition to triggering the process to proceed to step 130, also update an asset database of the assets 230 of the organization 201. In another example, the computing device 210 or other computing device can perform a scan of the network of organization 201 and confirm that all found assets are in the asset database. If an asset 230 is not in the asset database, it is flagged as a new asset and the event trigger is created. In another example, the addition of a new asset 230 and detection of the same by the computer 210 can be the event trigger.

At step 120C, the computing device 210 determines that the event trigger is a publication of a threat advisory. At this step, the computing device 210 can correlate the threat advisory with the assets 230 of the organization to determine whether the threat is applicable or relevant. The threat advisory event trigger can be based on a continuous ingestion and correlation of global threat intelligence data from known sources with the assets 230 of the organization that is protected by the computing device 210. When a new threat advisory that could potentially impact the infrastructure/network of an organization is published by a source computing device 220, the computing device can trigger an event-driven simulation as discussed further herein. For example, the computing device 210 correlates the threat advisories with an asset database of the organization's assets 220 (the asset database can be stored in the computing device 210 executing the processes discussed here or in a storage computing device that is communicatively connected to the computing device).

At step 121C, the computing device 210 synchronizes the data of the threat advisory event trigger. The computing device 210 synchronizes the data to the client- or organization-specific instance. The synchronization can be considered to be an adaptation of the threat advisory event trigger to the specifics of the client—the assets, the network(s) and its components, location, etc.

In an embodiment, threat advisories published by an organization (for example, an organization such as the Applicant) and are fed into a central system which serves as a repository of all vulnerability and threat intelligence information collected by the organization. This database is synchronized with all instances of the platform running on the computing device 210 in real-time in-order to fuel the vulnerability correlation engine described above.

After the synchronization of step 121C, the computing device 210 can proceed to the check event step 130 or correlate the threat data with the assets and vulnerabilities at step 122C. The correlation can comprise a comparison of the threat data with the assets and vulnerabilities—for example, to check if a particular threat is associated with or likely to target a particular asset or if an asset has a particular vulnerability that a particular threat is associated with. If no correlations exist, the computing device 210 can proceed to execute the check event at step 130.

If a correlation with an asset 230 is made, the computing device 210 then determines whether the asset 230 is a critical asset that would be impacted by the threat. A critical asset can be one considered to be one of high importance within a system or a network. In this example, the assets within an organization or a system can be ranked or tiered according to criticality, such that the computing device 210 can consult the pre-defined list of criticality.

In embodiments of the inventive subject matter, step 120 can generally entail determining, by the computing device 210, if a new threat advisory is received by the system from an external cloud service which publishes the advisories on demand that sends threat advisories to all the client platforms in the respective computing device 210 deployed at customer premises. The step 120 would also entail determining if a new asset has been added to the system or a new vulnerability is added to the system by the platform services.

In embodiments of the inventive subject matter, Determination of Asset Criticality is also performed by the correlation engine discussed above, wherein a high-level criticality of the network zone/VLAN/Sub-Net is taken as a user input and is used as a baseline criticality for all assets falling in that network zone/VLAN/sub-net. This baseline criticality is contextualized with additional meta data such as open ports, services running, operating system, applications installed, etc. collected by the computing device 210 about an asset by mean of active scans and/or integrations with other technologies such as CMDB or cybersecurity asset management solutions.

At this stage, the computing device 210 passes to step 130.

At step 130, the computing device 210 performs a check on the event. In embodiments, Events are created on the platform by end-users as per their organizational and risk requirements and thus, each instance of the event database is highly customized to the organization deploying the platform/system discussed herein and executed by the computing device 210. Step 130 checks for these events in the infrastructure based on data collected and/or actions taken and/or behavior of the platform in that specific environment.

The events are real events that are generated in the customer systems 230 of organization 201 or as part of processes that connected to the system via computing devices 220. A process related event could be a new asset is added to the organization's network, this would be detected the computing device 210 in the next scan. Another event could be a critical vulnerability is found on this asset.

Step 130 can also include a determination by the computing device 210 of a list of attacks that need to be simulated that are correlated with the event(s). The list can be obtained from a service, or can be derived based on the types of attacks that are typically associated with those event(s).

If the event checks out at step 130 (the check being a check for the occurrence of the events defined by end-users on the platform), the computing device 210 performs a simulation at step 140. The execution of step 140 can include one single simulated attack, or a plurality of attacks, depending on the listed events determined at step 130.

A simulation can be considered to be a controlled exploitation of vulnerabilities and misconfigurations performed to mimic a threat actor behavior and create an artificial cyber-attack on the target infrastructure to determine the efficacy of the security controls deployed by an organization.

Simulations can have many different types. Some examples include, but are not limited to, malware attack simulations, ransomware attack simulations, web application attack simulations, or vulnerability attack simulations.

If the simulation is successful, the computing device 210 then validates security controls at step 150. Generally speaking, the validation of the security controls can be considered to be a review of the security controls that were implemented or invoked in the simulated attack(s) and how effective or successful each security control was in blocking (or failing to block) the simulated attack(s).

The core objective of breach and attack simulation is to check the effectiveness of existing security controls such as firewalls, IDPS, EDR etc. Breach & Attack simulation platforms collect and analyze logs generated on these security controls to determine if a simulated attack was detected and prevented by these controls and assess their readiness to detect and prevent a real attack if and when they happen.

Security controls are tested/validated by the computing device 210 creating and deploying attacks that mimic the behaviors of real-world ransomware or malware or other threat types. These attacks are then executed in such a way that the attack path passes through the security control (such as a firewall for instance) that protects the network and devices 230 of organization 201. If the security control is able to detect, alert and block/quarantine the threat, then the security control is considered effective in blocking that threat/attack. Another step to check if security control has a policy configured to detect such attacks, or just monitor them or block them.

As part of validation, the computing device 210 can check if that simulation could successfully download and store the attack payload to the target, and could also execute the attack payload on the target.

If the simulation is not successful, the computing device 210 generates an error message at step 190 and ends the process.

Following the validation of step 150, the computing device 210 then determines whether the simulated attack is correlated with a vulnerability at step 160. At this step, the output of a simulation is correlated, by the computing device 210, with the vulnerability data to adjust the risk score assigned to vulnerabilities by the correlation engine. The risk score can be determined based on a history of simulated or actual attacks and responses which can be updated with each simulated attack or real attack, and can represent a likelihood that an attack on the vulnerability of the asset would be successful. A successful simulation that was neither prevented nor detected by any security control corresponds to a higher risk compared to the ones which are prevented or detected and also indicated higher chances of exploitation of the vulnerability which is associated with the simulation. The risk score can be based on factors such a calculation based on various factors like if the vulnerability is exploitable, if the asset that it is affected is internet facing, the criticality of the asset itself. The risk score therefore represents a quantitative determination of likelihood of the risk.

If the simulated attack is correlated with a known vulnerability, the computing device 210 adjusts the vulnerability risk at step 170 and then generates a report at step 180. The adjustment can be based on a risk of all the vulnerabilities correlated with the attack and consequently risk score of all the assets that contain the same set of vulnerabilities.

If the simulated attack is not correlated with a known vulnerability, the computing device 210 proceeds to generate a report at step 180.

In addition to generating a report, step 180 can include the computing device 210 taking remedial actions based on the results of the process. The remedial actions can include isolating a vulnerable asset 230 (such as isolating it from network contact with other assets 230 and/or from contact with devices outside of the organization 201), updating security software of one or more of the assets 230, reprioritizing the assets 230, updating the assets database, among other actions.

In one example, remedial actions may include a number of steps:
1) Update the threat signature in the endpoint security control—this falls under mitigation strategies,
2) Update the policy in the network security control to block the malicious files and known associated IP address/URLs from where these files originate, to prevent them from entering the network,
3) Increase the risk score of the asset and also, of the exploitable vulnerability that was detected using the simulation,
4) Add asset level policies to monitor or block the system services or processes that are affected due to this vulnerability,
4) If there are known patches available to remediate the vulnerability, then create a ticket so that IT support team take action

In embodiments, actions can also include adjusting the risk score of all correlated vulnerabilities and assets and additionally actions like generating a report, sending an email to the concerned asset owners can also be possible actions.

In embodiments of the inventive subject matter, the process of FIG. 1 can be repeated if a result is inconclusive or if the simulation determines that there is a threat or vulnerability that cannot be overcome by traditional measures.

FIG. 2 is a diagrammatic overview of a system 200 that implements the processes discussed herein, according to embodiments of the inventive subject matter. As seen in FIG. 2, the system 200 includes a computing device 210 that executes processes and functions discussed herein. The computing device 210 can be one single computer or more than one individual computers working cooperatively. The computing device 210 is shown as being communicatively coupled with one or more source computers 220. The source computing devices 220 can gather and provide one or more types of event triggers. For example, the source computing devices 220 can generate and provide event triggers related to threat advisories.

System 200 also includes a plurality or collection of assets 230 belonging to an organization 201, which can include computing devices of various types as well as other machines and devices that have computing functions (e.g., printers, manufacturing equipment, security systems, medical equipment, scanners, cameras, etc.). In the example shown in FIG. 2, the computing device 210 is also within the organization 201. However, in embodiments, the computing device 210 can be operated by a third party. The assets 230 can all be networked together within the organization 201, but this is not strictly required—for example, some assets 230 can be in one network and other assets 230 in a separate network within the organization 201.

By aligning simulations with real-world events, the event-driven simulations of the inventive subject matter ensure that each test is relevant to the current security landscape. This targeted approach provides organizations with actionable insights, allowing security teams to focus on high-priority risks and vulnerabilities rather than generic testing.

The event-driven simulations of the inventive subject matter significantly reduce the amount of noise generated by unnecessary or irrelevant alerts. By focusing on specific events—such as newly discovered assets or critical vulnerabilities—simulations are more aligned with real threats, making the SOC's workload more manageable and efficient.

With the event-driven simulations of the inventive subject matter, organizations can adopt a more proactive approach to cybersecurity. Instead of waiting for scheduled tests, defenses are validated as soon as new threats or vulnerabilities are detected, ensuring that the organization remains protected against evolving risks.

Security teams can customize the conditions under which simulations are triggered, choosing between fully automated, manual, or scheduled simulations. This flexibility ensures that teams have control over the testing process while benefiting from automation.

Additional benefits of the systems and methods of the inventive subject matter can include:

Responding to emerging threats: When a new vulnerability or exploit is discovered in the wild, organizations are often slow to react. The systems and methods of the inventive subject matter, organizations can automatically test their defenses as soon as a new threat advisory is published. This ensures that critical vulnerabilities are identified and mitigated before attackers can exploit them.

Validating security posture after asset changes: As organizations grow and evolve, new devices, servers, and endpoints are added to their networks. The systems and methods of the inventive subject matter automatically validate the security posture of these newly discovered assets, ensuring that they are protected from known threats and vulnerabilities from the moment they are deployed.

Prioritizing remediation based on real-world risk: Security teams are often overwhelmed with vulnerability data, making it difficult to prioritize remediation efforts. By correlating vulnerability scan data with active threats, the systems and methods of the inventive subject matter provide clarity on which vulnerabilities pose the greatest risk, helping security teams focus their remediation efforts on the most critical issues.

Additionally, it can be appreciated that the event-driven attack simulation systems and methods described herein can provide substantial computing resources. Consider the following example:

Typically, there is one target per vlan/dept in customer deployments. And if the security requirements are that 5000 attacks to be simulated continuously or periodically, the resource needs per target are=5000 attacks*50% cpu utilization (representative)*5 secs avg duration per attack simulation.

In contrast, because the systems and methods of the inventive subject matter involve event driven attack simulation invention, the resource needs per target are=50/100 attacks (representative attacks affected by the event)*50% cpu utilization (representative)*5 secs avg duration per attack simulation.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for executing a breach and attack simulation, comprising:
receiving, by a computer system, an event trigger associated with a real-world event;
checking, by the computer system, the event;
determining, by the computer system, the list of attacks to be simulated which are correlated to the event
running, by the computer system, at least one determined attack simulation based on the event;
determining, by the computer system, that the at least one attack simulation concluded successfully;
validating, by the computer system the list of security controls that helped block or failed to block the at least one attack simulation;
determining, by the computer system, whether a simulated attack executed during the simulation is correlated with a vulnerability on at least one asset within a collection of assets;
based on a determination that the simulated attack is correlated with the vulnerability on the at least one asset, adjusting, by the computer system, at least one of a vulnerability risk and an asset risk based on the at least one attack simulation result;
executing an action, by the computing device.

2. The method of claim 1, wherein the real-world event comprises a threat advisory corresponding to a threat, wherein the step of receiving the event trigger comprises:
receiving, by the computer system, the threat advisory;
synchronizing, by the computer system, threat data from the threat advisory with stored platform data stored by the computer system;
determining, by the computer system, that the threat data is correlated with at least one of an asset and a vulnerability of a network comprising a plurality of assets; and
determining, by the computer system and based on the determination that the threat data is correlated with the at least one of the asset and the vulnerability of the network, whether any asset from the plurality assets of the network is impacted by the threat.

3. The method of claim 1, wherein the real-world event comprises an addition to an asset to a network.

4. The method of claim 3, further comprising:
determining, by the computer system, that the asset was added to the network;
causing a simulation agent to be installed on at least one of the newly-added asset or a preexisting asset on the network, the simulation agent being programmed to running the at least one attack simulation; and
running, by the computer system, the at least one attack simulation on the at least one newly-added asset or preexisting asset.

5. The method of claim 1, wherein the real-world event comprises a result of a vulnerability scan, and the step of receiving the event trigger further comprises:
determining, by the computer system and for the collection of assets, a priority of at least one vulnerability based on the vulnerability scan;
in parallel, determining, by the computer system, whether any previously-known vulnerability comprises a critical vulnerability, wherein a critical vulnerability is a vulnerability that has been exploited or with a high probability of being exploited;
designating, by the computer system, an asset within the collection of assets as a critical asset based on the priority of the at least one vulnerability;
determining whether the critical asset would be impacted by one of the at least one vulnerability and the critical vulnerability; and
running, by the computer system, the at least one determined attack simulation based on the event.

6. A system comprising at least one non-transitory computer-readable storage medium storing instructions that, when executed by at least one processor, cause the at least one processor to execute the steps of:
receiving an event trigger associated with a real-world event;
checking the event;
determining the list of attacks to be simulated which are correlated to the event running at least one determined attack simulation based on the event;
determining that the at least one attack simulation concluded successfully;
validating the list of security controls that helped block or failed to block the at least one attack simulation;
determining whether a simulated attack executed during the simulation is correlated with a vulnerability on at least one asset within a collection of assets;
based on a determination that the simulated attack is correlated with the vulnerability on the at least one asset, adjusting, by the computer system, at least one of a vulnerability risk and an asset risk based on the at least one attack simulation result;
executing an action, by the computing device.

7. The system of claim 6, wherein the real-world event comprises a threat advisory corresponding to a threat, wherein the step of receiving the event trigger further comprises instructions that cause the at least one processor to execute the steps of:
receiving the threat advisory;
synchronizing threat data from the threat advisory with stored platform data;
determining that the threat data is correlated with at least one of an asset and a vulnerability of a network comprising a plurality of assets; and
determining, based on the determination that the threat data is correlated with the at least one of the asset and the vulnerability of the network, whether any asset from the plurality assets of the network is impacted by the threat.

8. The system of claim 6, wherein the real-world event comprises an addition to an asset to a network.

9. The system of claim 8, further comprising instructions that cause the at least one processor to execute the steps of:
determining that the asset was added to the network;
causing a simulation agent to be installed on at least one of the newly-added asset or a preexisting asset on the network, the simulation agent being programmed to running the at least one attack simulation; and
running the at least one attack simulation on the at least one newly-added asset or preexisting asset.

10. The system of claim 6, wherein the real-world event comprises a result of a vulnerability scan, and wherein the step of receiving the event trigger further comprises instructions that cause the at least one processor to execute the steps of:
determining, for the collection of assets, a priority of at least one vulnerability based on the vulnerability scan;
in parallel, determining whether any previously-known vulnerability comprises a critical vulnerability, wherein a critical vulnerability is a vulnerability that has been exploited or with a high probability of being exploited;
designating an asset within the collection of assets as a critical asset based on the priority of the at least one vulnerability;
determining whether the critical asset would be impacted by one of the at least one vulnerability and the critical vulnerability; and
running, by the computer system, the at least one determined attack simulation based on the event.
